(19) United States
(12) Patent Application Publication
(10) Pub. No.: US 2026/0066581 A1
(43) Pub. Date: Mar. 5, 2026

(54) ELECTRICAL CONNECTOR AND ELECTRICAL CONNECTOR ASSEMBLY

(71) Applicants: FOXCONN (KUNSHAN) COMPUTER CONNECTOR CO., LTD., Kunshan (CN); FOXCONN INTERCONNECT TECHNOLOGY LIMITED, Grand Cayman (KY)

(72) Inventors: YANG-TSUN HSU, New Taipei (TW); JERRY WU, Irvine, CA (US); JUN CHEN, Kunshan (CN); XIAO FAN, Huaian (CN)

(21) Appl. No.: 19/310,060

(22) Filed: Aug. 26, 2025

(30) Foreign Application Priority Data
Aug. 27, 2024 (CN) 202411182346.8

(51) Int. Cl. H01R 13/631; H01R 12/72; H01R 12/75

(52) U.S. Cl. CPC H01R 13/631; H01R 12/722; H01R 12/75

(57) ABSTRACT

An electrical connector includes: a cable extending along a first direction; a terminal connected to the cable; a housing including: a top portion, a bottom portion, and a first side wall and a second side wall between the top and the bottom; a cavity receiving the terminal and extending along a second direction perpendicular to the first direction, the cavity being in fluid communication with an opening of the bottom portion for entry of a mating terminal; and a latch accommodating channel in communication with the cavity; and a latch movably received in the latch accommodating channel and configured to engage the mating terminal in a locked position and to release the mating terminal in an unlocked position, wherein the latch is able to reciprocate along a third direction perpendicular to the first direction and the second direction to achieve the locked position and the unlocked position.

### BACKGROUND OF THE INVENTION

### Field of the Invention

The present invention generally relates to an electrical connector and electrical connector assembly for transmitting large currents.

### Description of Related Arts

In large current transmission application scenarios, stable current transmission is crucial. To ensure the stability and safety of power transmission, it is necessary to design a locking mechanism on the connector to prevent accidents or disengagement, ensure safety and connection stability during large current transmission, and ensure the continuity of current transmission and the normal operation of the equipment.

U.S. Pat. No. 11,670,893 discloses a socket connector including a housing having a pin access opening through a bottom open to a cavity configured to receive a pin. The socket connector includes a socket in the cavity electrically connected to a pin. The socket connector includes a latch movably received in a latch pocket to engage the pin to secure the socket connector to the pin. The latch includes a latch release accessible exterior of the housing to release the latch. The latch release moves the latch between a latched position and a clearance position. A latching rib of the latch engages the pin in the latched position and is released from the pin in the clearance position to allow uncoupling of the socket connector from the pin. The latch relies on the elastic force generated by the latch arm to reset so under frequent use it may not provide sufficient stability and reliability. Therefore, an improved electrical connector is desired.

### SUMMARY OF THE INVENTION

The main object of the present invention is to provide an improved electrical connector and electrical connector assembly, wherein the electrical connector can achieve a more reliable and stable connection with its mating connector.

To achieve the above-mentioned object, an electrical connector comprises: a cable extending along a first direction; a terminal connected to the cable; a housing comprising: a top portion, a bottom portion, and a first side wall and a second side wall between the top and the bottom; a cavity receiving the terminal and extending along a second direction perpendicular to the first direction, the cavity being in fluid communication with an opening of the bottom portion for entry of a mating terminal; and a latch accommodating channel in communication with the cavity; and a latch movably received in the latch accommodating channel and configured to engage the mating terminal in a locked position and to release the mating terminal in an unlocked position; wherein the latch is able to reciprocate along a third direction perpendicular to the first direction and the second direction to achieve the locked position and the unlocked position.

To achieve the above-mentioned object, an electrical connector comprises: a cable extending along a first direction; a first terminal and a second terminal connected to the cable; a housing comprising: a top portion, a bottom portion, and a first side wall and a second side wall between the top portion and the bottom portion; a first cavity and a second cavity respectively accommodating the first terminal and the second terminal and extending along a second direction perpendicular to the first direction, the bottom portion comprising a pair of openings connected respectively to the first cavity and the second cavity for a pair of mating terminals to enter the first cavity and the second cavity through the pair of the openings to be electrically connected to the first contact terminal and the second contact terminal; and a latch accommodating channel in communication with the first cavity and the second cavity; and a latch movably received in the latch accommodating channel and configured to engage the mating terminals in a locked position and to release the mating terminals in an unlocked position; wherein the latch is able to reciprocate along a third direction perpendicular to the first direction and the second direction to achieve the locked position and the unlocked position.

To achieve the above-mentioned object, an electrical connector assembly comprises: a board-end connector comprising a first mating terminal, a second mating terminal, and a substrate holding the first mating terminal and the second mating terminal; and a cable-end connector mating with the board-end connector, comprising: a cable extending along a first direction; a first terminal and a second terminal connected to the cable; a housing comprising: a top, a bottom, and a first side wall and a second side wall between the top and the bottom; a first cavity and a second cavity respectively accommodating the first terminal and the second terminal and extending along a second direction perpendicular to the first direction, the bottom comprising a pair of openings connected to the first cavity and the second cavity, the first mating terminal and the second mating terminal respectively entering the first cavity and the second cavity through the pair of the openings to be electrically connected respectively to the first contact terminal and the second contact terminal; and a latch accommodating channel in communication with the first cavity and the second cavity; and a latch movably received in the latch accommodating channel and configured to engage the first mating terminal and the second mating terminal in a locked position to lock the cable-end connector with the board-end connector, and to release the first mating terminal and the second mating terminal in an unlocked position to unlock the cable-end connector from the board-end connector; wherein the latch is able to reciprocate along a third direction perpendicular to the first direction and the second direction to achieve unlocking and locking of the cable-end connector and the board-end connector.

Compared to prior art, the electrical connector and the electrical connector assembly of the present invention realizes a more reliable and stable connection with its mating connector through the design of the latch structure, thereby ensuring the safety and stability of power transmission.

### BRIEF DESCRIPTION OF DRAWINGS

FIG. 1 is a perspective view of an electrical connector assembly, with a cable-end connector and a board-end connector being in a locked state;

FIG. 2 is a perspective view of the electrical connector assembly shown in FIG. 1, with the cable-end connector and the board-end connector being in an unlocked state;

FIG. 3 is a perspective view of the cable-end connector and the board-end connector;

FIG. 4 is another perspective view of the cable-end connector and the board-end connector;

FIG. 5 is a exploded view of the cable-end connector shown in FIG. 3;

FIG. 6 is another exploded view of the cable-end connector shown in FIG. 5;

FIG. 7 is a cross-sectional view of the electrical connector assembly shown in FIG. 1 taken along line A-A, wherein the latch is in the locked position;

FIG. 8 is a cross-sectional view of the electrical connector assembly shown in FIG. 2 taken along line B-B, wherein the latch is in the unlocked position; and

FIG. 9 is a cross-sectional view of the electrical connector assembly shown in FIG. 1 taken along line C-C.

### DETAILED DESCRIPTION OF DRAWINGS

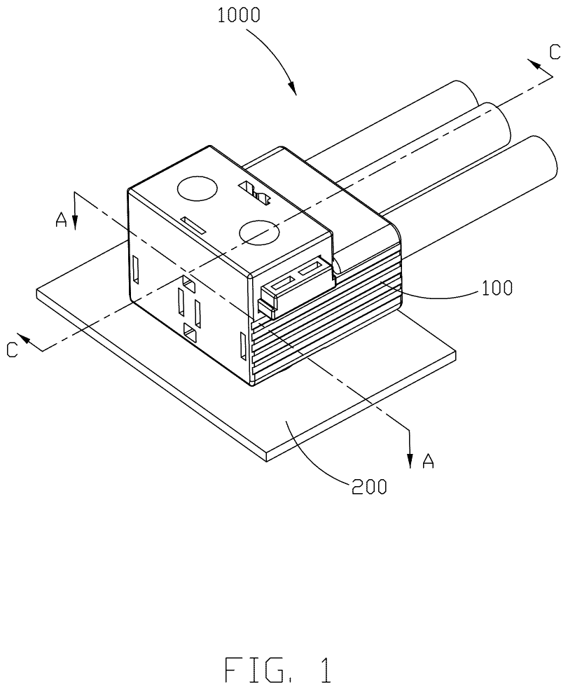

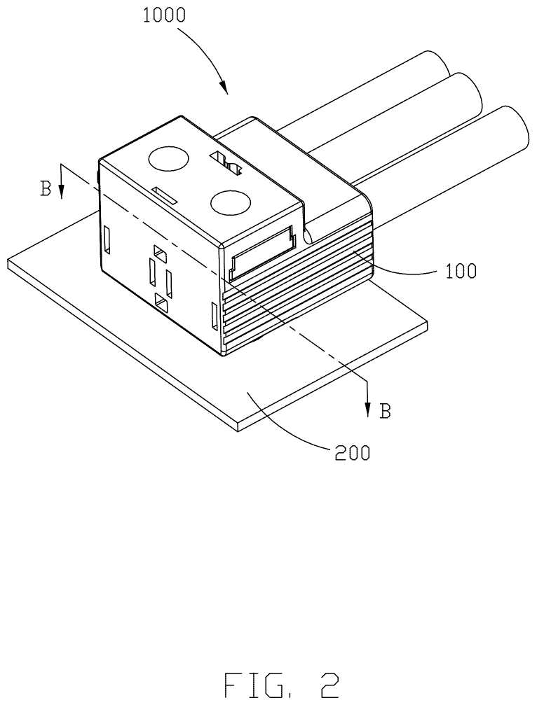

FIGS. 1-9 show an electrical connector assembly 1000 of the present invention. The electrical connector assembly 1000 includes a cable-end connector 100 and a board-end connector 200 mating with the cable connector 100. The cable connector 100 includes a housing 110, a terminal 120 disposed in the housing, a cable 130 extending along a first direction and connected with the terminal 120, and a latch 140 disposed in the housing 110. The cable-end connector 100 is configured to be lockably connected to the board-end connector 200 by the latch 140. As shown in FIGS. 1, 7, and 9, the cable-end connector 100 is lockingly connected to the board end connector 200. In this embodiment, the cable-end connector 100 is provided with a pair of terminals 120, including a first terminal 121 and a second terminal 122. Correspondingly, the board-end connector 200 is provided with a pair of mating terminals 210, including a first mating terminal 211 mating with the first terminal 121 and a second mating terminal 212 mating with the second terminal 122. It can be known that, in other embodiments, the cable-end connector 100 and the board-end connector 200 may have more or fewer terminals and mating terminals. That is, the number of terminals of cable-end connector and the board-end connector may be set according to the specific power or current to be transmitted.

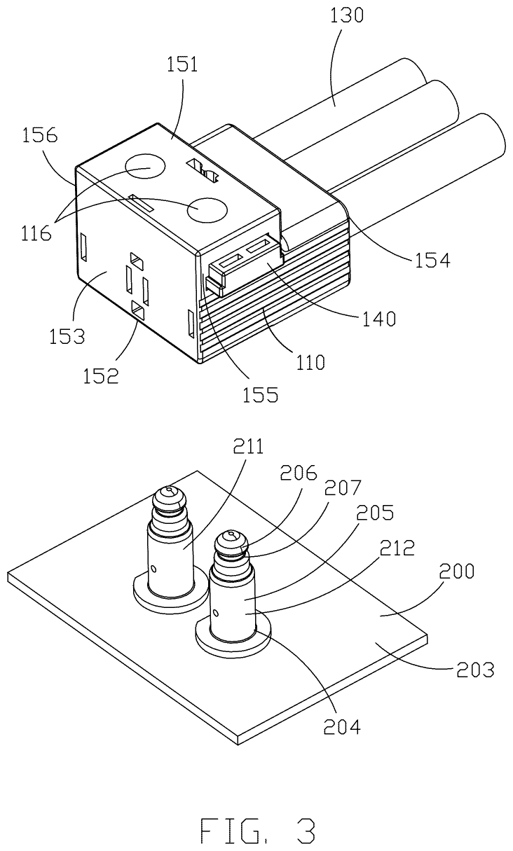

Referring to FIG. 3, the board-end connector 200 includes a substrate 203 holding the first mating terminal 211 and the second mating terminal 212, and the first mating terminal 211 and the second mating terminal may be connected to the substrate 203 by press-fit connection or by screws. In this embodiment, the substrate 203 is a circuit board. In other embodiments, the substrate 203 may be a bus bar. The first mating terminal 211 and the second mating terminal 212 each include a connecting portion 204 connecting to the substrate 203, a mating end 205 connecting to the terminal 120, and an extending end 206 extending from the mating end 205 in a direction away from the connecting portion 204. The extending end 206 is provided with an inwardly recessed groove 207, and the groove 207 is formed to engage the latch 140 to lock the board-end connector 200 with the cable-end connector 100.

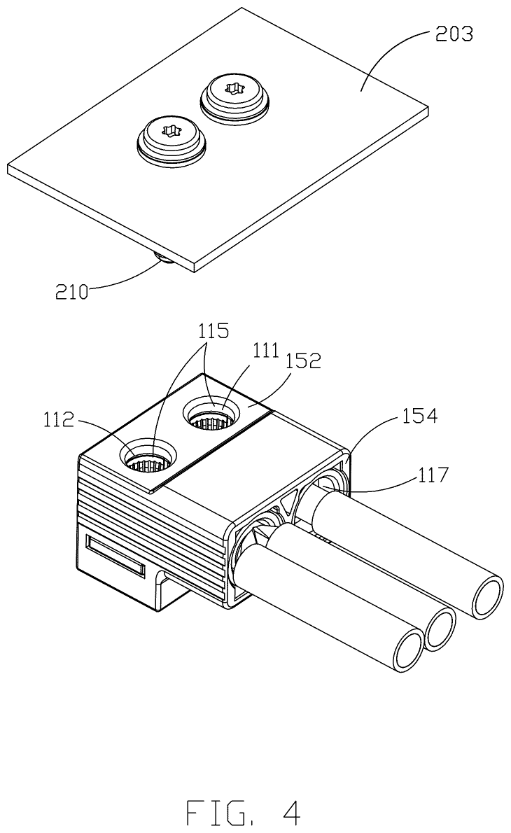

Referring to FIGS. 3-4, the housing 110 includes a top portion 151, a bottom portion 152, a front portion 153, a rear portion 154, a first side wall 155, and a second side wall 156. The first side wall 155 and the second side wall 156 are each disposed between the top portion 151, the bottom portion 152, the front portion 153, and the rear portion 154. The housing 110 includes a first cavity 111 and a second cavity 112 for accommodating the first terminal 121 and the second terminal 122, respectively, and a latch accommodating channel 113 communicating with the first cavity 111 and the second cavity 112. The first cavity 111 and the second cavity 112 extend along a second direction perpendicular to the first direction and are separated by a partition wall 114 disposed in the housing 110. The bottom portion 152 is provided with a pair of bottom openings 115 in fluid communication with the first cavity 111 and the second cavity 112 respectively. The first mating terminal 211 and the second mating terminal 212 can respectively enter the first cavity 111 and the second cavity 112 through the pair of bottom openings 115 to be electrically connected with the corresponding terminals. The top 151 is provided with a pair of top openings 116. The first cavity 111 and the second cavity 112 are each communicated with the latch accommodating channel 113 and communicate respectively with the top openings 116. The rear 154 is provided with a pair of rear openings 117 in communication with the first cavity 111 and the second cavity 112 and through which the cable 130 can extend out.

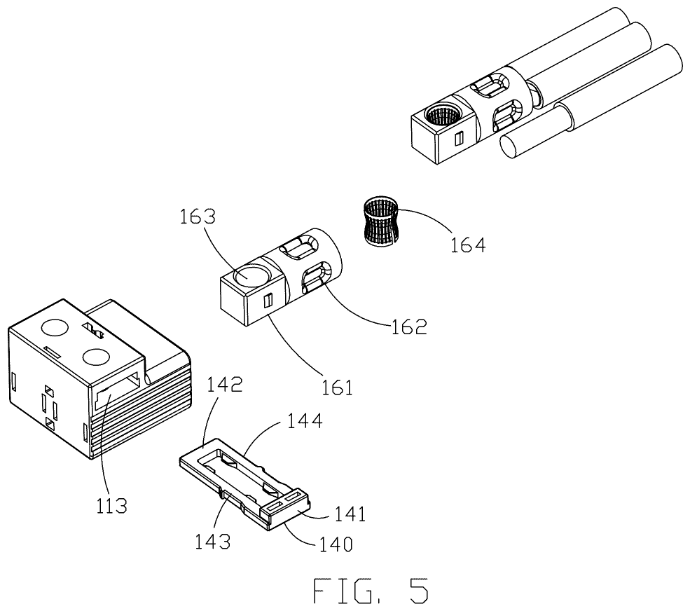

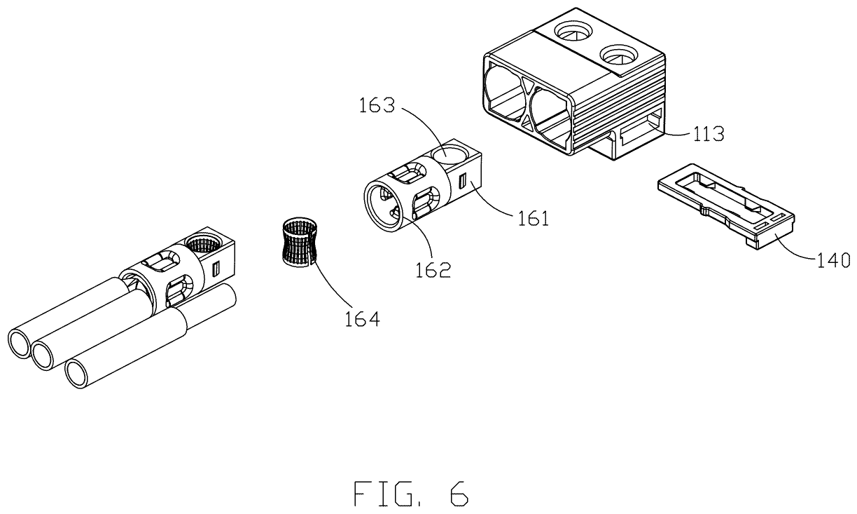

Referring to FIGS. 5-6, the first terminal 121 and the second terminal 122 each include a mating end 161 connected to the first mating terminal 211 and the second mating terminal 212, and a connecting end 162 connected to the cable 130. The mating end 161 includes a hole 163, and a crown spring terminal 164 disposed in the hole 163. The first mating terminal 201 and the second mating terminal 202 respectively enter the corresponding hole 163 and connect to the crown spring terminal 164.

Referring to FIGS. 5-8, the latch accommodating channel 113 is a channel that penetrates the first side wall 155 and the second side wall 156 along a third direction perpendicular to the first direction and the second direction. The latch 140 includes a first pressing portion 141, a second pressing portion 142 opposite to the first pressing portion 141, and a first arm 143 and a second arm 144 connecting the first pressing portion 141 and the second pressing portion 142. In this embodiment, the latch 140 is an integrated rectangular structure that surrounds the first mating terminal 211 and the second mating terminal 212 and allows them to extend out. The inner side of the first arm 143 is provided with a first engaging portion 145 to engage the groove 207 of the mating terminal 210. The inner side of the second arm 144 is provided with a second engaging portion 146 to engage the groove 207 of the mating terminal 210. The shapes and sizes of the first engaging portion 145 and the second engaging portion 146 are configured to be suitable for engaging the groove 207, and the first engaging portion 145 and the second engaging portion 146 simultaneously engage the groove 207 in a direction perpendicular to the moving direction of the latch 140 to lock the mating terminal 210. In some embodiments, the first engaging portion 145 and the second engaging portion 146 are aligned. In this embodiment, the first arm 143 and the second arm 144 are provided with four engaging portions, respectively locking the first mating terminal 211 and the second mating terminal 212. In other embodiment, the number of the first engaging portions and the second engaging portions can be set according to the number of the mating terminals 210. The latch 140 is also provided with a limiting portion 170 to keep the latch 140 in the latch accommodating channel 113 at all times regardless of whether the latch 140 is in a locked or unlocked position. The limiting portion 170 includes a first protrusion 171 disposed on the outside of the first arm 143 and a second protrusion 172 disposed on the outside of the second arm 144. The housing 110 is provided with a first limiting space 181 to limit the first protrusion 171 and a second limiting portion 182 to limit the second protrusion 172. The first limiting space 181 is in the shape of a rectangular recess and includes a first stop surface 183 and a second stop surface 184. The second limiting portion 182 includes a first receiving space 185, a second receiving space 186, and a restricting member 189 between the first receiving space 185 and the second receiving space 186. The limiting portion 170 also includes a recess 173 disposed on the outer side of the first arm 143 and a recess 174 disposed on the outer side of the second arm 144, and the housing 110 is provided with a third protrusion 187 and a third protrusion 188 at corresponding positions of the recesses 173, 174.

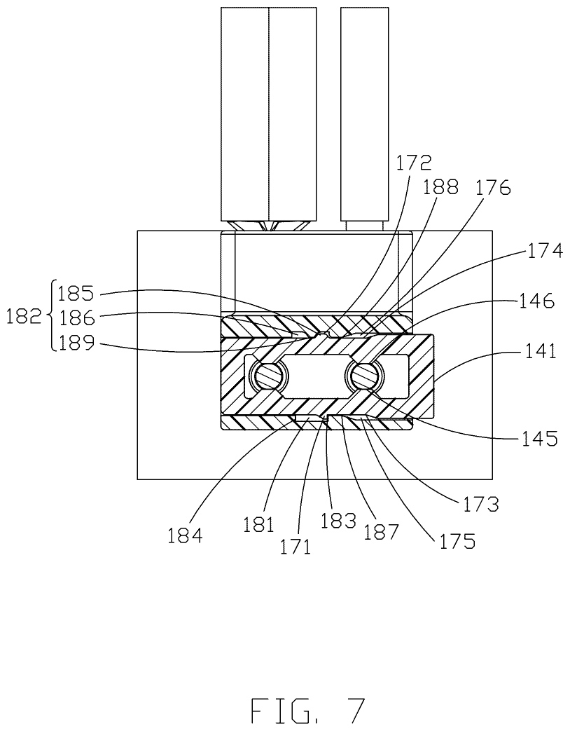

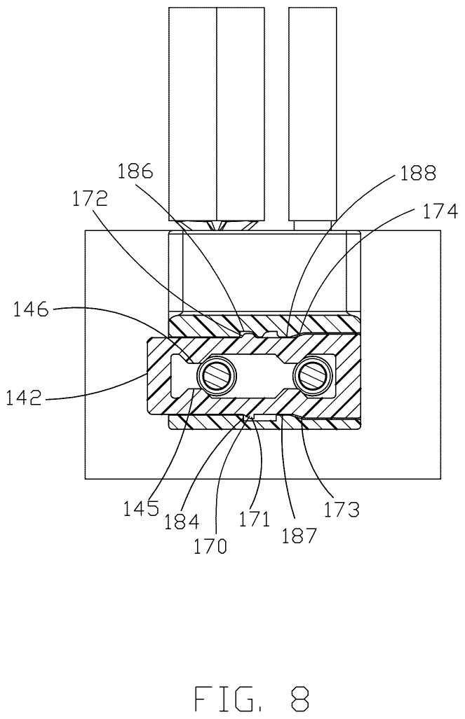

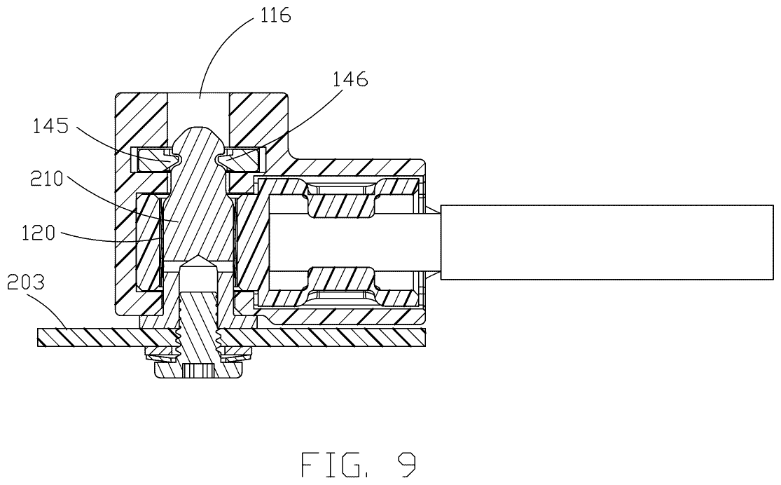

Referring to FIG. 7 and FIG. 9, when in the locked position, the first pressing portion 141 is exposed by the first side wall 155 of the housing 110, the first engaging portion 145 and the second engaging portion 146 engage the mating terminal 210 to lock it, the first protrusion 171 stops at the first stop surface 183, the second protrusion 172 is received in the first receiving space 185, a gap 175 is formed between the recess 173 and the third protrusion 187, and a gap 176 is formed between the recess 174 and the third protrusion 188. As shown in FIG. 8, the latch is in the unlocked position. During the process of the latch moving from the locked position to the unlocked position, the first pressing portion 141 is actuated to move along the third direction into the latch accommodation channel 113, the first engaging portion 145 and the second engaging portion 146 release the mating terminal 210, the first protrusion 171 moves away from the first stop surface 183 toward the second stop surface 184 and stops at the second stop surface 184, the second protrusion 172 escapes from the first receiving portion 185, moves across the restricting member 189 until it is received in the second receiving space 186. the gaps 175, 176 gradually become smaller and approach zero, the second pressing portion 142 is exposed by the side wall 156 of the housing 110. At this time, the cable-end connector 100 can be removed from the board-end connector 200 without any obstruction.

On the contrary, when the latch is moved from the unlocked position to the locked position, the second pressing portion 142 is actuated to move into the latch accommodation portion 113, the first engaging portion 145 and the second engaging portion 146 engage the groove 207 of the mating terminal 210, the first protrusion 171 moves away from the second stop surface 184 toward the first stop surface 183 and stops at the first stop surface 183, the second protrusion 172 escapes from the second receiving space 186, moves across the restricting member 189 until it is received in the first receiving space 185. the gap 175 is formed between the recess 173 and the third protrusion 187, and the gap 176 is formed between the recess 174 and the third protrusion 188. The first pressing portion 141 is exposed by the first side wall 155 of the housing 110, and at this time, the cable-end connector 100 and the board-end connector are reliably and stably locked together.

The cable-end connector in the present invention realizes a more reliable and stable connection with the board-end connector through the design of the latch structure, thereby ensuring the safety and stability of power transmission.

1. An electrical connector comprising:
a cable extending along a first direction;
a terminal connected to the cable;
a housing comprising:
a top portion, a bottom portion, and a first side wall and a second side wall between the top and the bottom;
a cavity receiving the terminal and extending along a second direction perpendicular to the first direction, the cavity being in fluid communication with an opening of the bottom portion for entry of a mating terminal; and
a latch accommodating channel in communication with the cavity; and
a latch movably received in the latch accommodating channel and configured to engage the mating terminal in a locked position and to release the mating terminal in an unlocked position; wherein
the latch is able to reciprocate along a third direction perpendicular to the first direction and the second direction to achieve the locked position and the unlocked position.

2. The electrical connector as claimed in claim 1, wherein the latch comprises a pressing portion, a first engaging portion for engaging the mating terminal, and a limiting portion coupled to the housing.

3. The electrical connector as claimed in claim 2, wherein the pressing portion comprises a first pressing portion and a second pressing portion opposite to the first pressing portion, and the latch and the mating terminal are unlocked and locked by pressing the first pressing portion and the second pressing portion respectively.

4. The electrical connector as claimed in claim 3, wherein the latch comprises a first arm and a second arm connecting the first pressing portion and the second pressing portion, the engaging portion comprises a first engaging portion protruding from the inner side of the first arm and a second engaging portion protruding from the inner side of the second arm, the first engaging portion and the second engaging portion engage the mating terminal to achieve locking of the electrical connector and the mating terminal.

5. The electrical connector as claimed in claim 4, wherein the limiting portion comprises a first protrusion disposed on the outer side of the first arm and a second protrusion disposed on the outer side of the second arm, the latch accommodating channel is respectively provided with a first limiting space for limiting the first protrusion and a second limiting portion for limiting the second protrusion.

6. The electrical connector as claimed in claim 5, wherein the first limiting space comprises a first stop surface and a second stop surface, the second limiting portion comprises a restricting member, when the latch moves from the locked position to the unlocked position, the first protrusion moves from the first stop surface to the second stop surface, and the second protrusion moves across the restricting member.

7. The electrical connector as claimed in claim 6, wherein the limiting portion comprises recesses respectively arranged on the outside of the first arm and the second arm, the latch receiving portion is provided with a third protrusion at a corresponding position, in the locked position, there is a gap between the recess and the protrusion, when the latch moves from the locked position to the unlocked position, the gap between the recess and the protrusion gradually decreases until the recess and the protrusion are in contact without a gap.

8. An electrical connector comprising:
a cable extending along a first direction;
a first terminal and a second terminal connected to the cable;
a housing comprising:
a top portion, a bottom portion, and a first side wall and a second side wall between the top portion and the bottom portion;
a first cavity and a second cavity respectively accommodating the first terminal and the second terminal and extending along a second direction perpendicular to the first direction, the bottom portion comprising a pair of openings connected respectively to the first cavity and the second cavity for a pair of mating terminals to enter the first cavity and the second cavity through the pair of the openings to be electrically connected to the first contact terminal and the second contact terminal; and
a latch accommodating channel in communication with the first cavity and the second cavity; and
a latch movably received in the latch accommodating channel and configured to engage the mating terminals in a locked position and to release the mating terminals in an unlocked position; wherein
the latch is able to reciprocate along a third direction perpendicular to the first direction and the second direction to achieve the locked position and the unlocked position.

9. The electrical connector as claimed in claim 8, wherein the latch is substantially in a rectangular shape that surrounds the mating terminals.

10. The electrical connector as claimed in claim 9, wherein the latch comprises a first pressing portion, a second pressing portion opposite to the first pressing portion, and a first arm and a second arm connecting the first pressing portion and the second pressing portion.

11. The electrical connector as claimed in claim 10, wherein a pair of first engaging portions are provided on the inner side of the first arm, and the first engaging portions respectively engage the pair of the mating terminals on one side, a pair of second engaging portions are provided on the inner side of the second arm, and the second engaging portions respectively engage the pair of the mating terminals on the other side opposite to the one side.

12. The electrical connector as claimed in claim 11, wherein when the second pressing portion is actuated to move into the latch accommodation channel, the first engaging portions and the second engaging portions engage the mating terminals, the first pressing portion is exposed by the first side wall, and at this time, the first and second terminals and the mating terminals are locked together, when the first pressing portion is actuated to move into the latch accommodation channel, the first engaging portions and the second engaging portions release the mating terminals, the second pressing portion is exposed by the second side wall, and at this time, the first and second terminals are able to be removed from the mating terminals without any obstruction.

13. The electrical connector as claimed in claim 12, wherein a first protrusion is disposed on the outer side of the first arm, and a second protrusion is disposed on the outer side of the second arm, the latch accommodating channel comprises a first limiting space for limiting the first protrusion and a second limiting portion for limiting the second protrusion.

14. The electrical connector as claimed in claim 13, wherein the first limiting space comprises a first stop surface and a second stop surface, the second limiting portion comprises a first receiving space and a second receiving space.

15. The electrical connector as claimed in claim 14, wherein the outer sides of the first arm and the second arm are each provided with a recess, and the latch accommodating channel is provided with a third protrusion at corresponding position, when the latch is in the locked position, there is a gap between the recess and corresponding third protrusion, and when the latch moves from the locked position to the unlocked position, the gap between the recess and corresponding third protrusion gradually decreases until the recess and corresponding third protrusion are in contact without a gap.

16. The electrical connector as claimed in claim 8, wherein the latch accommodating channel is a through channel that penetrates the first side wall and the second side wall along the third direction.

17. The electrical connector as claimed in claim 16, wherein the top portion is provided with a pair of top openings, the top openings, the latch accommodating channel, the first cavity, and the second cavity are in fluid communication with each other.

18. An electrical connector assembly comprising:
a board-end connector comprising a first mating terminal, a second mating terminal, and a substrate holding the first mating terminal and the second mating terminal; and
a cable-end connector mating with the board-end connector, comprising:
a cable extending along a first direction;
a first terminal and a second terminal connected to the cable;
a housing comprising:
a top, a bottom, and a first side wall and a second side wall between the top and the bottom;
a first cavity and a second cavity respectively accommodating the first terminal and the second terminal and extending along a second direction perpendicular to the first direction, the bottom comprising a pair of openings connected to the first cavity and the second cavity, the first mating terminal and the second mating terminal respectively entering the first cavity and the second cavity through the pair of the openings to be electrically connected respectively to the first contact terminal and the second contact terminal; and
a latch accommodating channel in communication with the first cavity and the second cavity; and
a latch movably received in the latch accommodating channel and configured to engage the first mating terminal and the second mating terminal in a locked position to lock the cable-end connector with the board-end connector, and to release the first mating terminal and the second mating terminal in an unlocked position to unlock the cable-end connector from the board-end connector; wherein the latch is able to reciprocate along a third direction perpendicular to the first direction and the second direction to achieve unlocking and locking of the cable-end connector and the board-end connector.

19. The electrical connector assembly as claimed in claim 18, wherein each of the first mating terminal and the second mating terminal comprises a connecting portion connecting to the substrate, a mating end connecting to the terminal of the cable-end connector, and an extending end extending from the mating end in a direction away from the connecting portion, the extending end has an inwardly recessed groove, and the groove is formed to engage the latch to lock the board-end connector with the cable-end connector.

20. The electrical connector assembly as claimed in claim 18, wherein the substrate is a circuit board or a bus bar.
